(19) United States
(12) Patent Application Publication
(10) Pub. No.: US 2003/0182147 A1
(43) Pub. Date: Sep. 25, 2003

(54) Web-based processing system for non-qualified benefits record keeping

(76) Inventors: Joseph Mahoney, Chester, PA (US); W. Christopher Garvin, Succasunna, NJ (US); Joseph Catalfamo, Belleville, NJ (US); Paul Reiss, West Caldwell, NJ (US)

Correspondence Address: DUANE MORRIS LLP, 100 COLLEGE ROAD WEST, SUITE 100, PRINCETON, NJ, 08540-6604, US

(21) Appl. No.: 10/337,083

(22) Filed: Jan. 6, 2003

Related U.S. Application Data
(60) Provisional application No. 60/346,427, filed on Jan. 7, 2002.

(51) Int. Cl. G06F 17/60

(52) U.S. Cl. 705/1

(57) ABSTRACT

A method and system for administering a benefit plan for a sponsor with a widely diverse participant population. Using a combination of Internet enabled tools and databases, participants can enter and confirm their own data. Plan sponsors can view that information with reference to plan parameters and guidelines coded into the benefit plan. Databases contain the plan choices, sponsor's rules, and who has access to which information. The system computes liabilities owed by the sponsor, assets used to informally fund those liabilities, and cost recovery opportunities, if any. The browser enabled system uses the advantages of the Worldwide Web (and any thin-client intranet on the sponsor's site) as its primary contact tool, with alternatives of telephone, modem, or fax. Financial information is provided to the plan sponsor as participants make choices, provides payout options to the participants, and provides considerably more interactivity than prior methods of servicing employee benefits.

This application claims the benefit of U.S. Provisional Patent Application No. 60/346,427, filed Jan. 7, 2002, which is incorporated by reference herein.

### FIELD OF THE INVENTION

The present invention relates to the field of computer systems generally, and more specifically to computer systems programmed to process transactions in employee benefit plans.

### BACKGROUND OF THE INVENTION

Employers rely on nonqualified or supplemental benefit plans to retain and attract competent executives. These plans provide benefits to selected plan participants over and above the benefits offered by traditional 401(k) and pension plans, whose limits may exclude executive participants from full use.

Executive benefit plans have become an important component of a well tuned executive retention program for businesses. Used in combination with salary, bonus, and stock options, an executive benefit program offers a tax favored alternative which may make a premature employment termination very expensive for the executive.

Prior to the mid-1980s, benefit programs were simple, and rarely were more complex than an employer's promise to pay an additional amount of retirement compensation, or to administer a private savings plan payable to the employee on retirement. Administration needs were minimal, and often not well served. Tax law changes affecting executive and highly compensated employees, especially deferral caps for 401(k) plans, and maximum income amounts available for pension inclusion have made these programs much more complex. These complex plans with different income inclusion/exclusion limits require an executive to make important decisions, and live with the financial outcomes.

The most common forms of nonqualified (or executive) plans include:

Supplemental Executive Retirement Plans (SERPs) to address the limits placed on income which may be counted toward a qualified pension plan. For the year 2001, that limit is $170,000 of income (Internal Revenue Code Section 401(a)). Income over $170,000 is not counted toward a qualified employer pension plan.

Deferred Compensation Plans (DCP) in which an executive may elect not to receive certain income, and the employer agrees to credit a hypothetical rate of interest on that deferral until the executive chooses to begin receiving the accumulations. A DCP is often used as a supplement for deferrals over the maximum 401(k) limit, which is currently $10,500 for most employees.

Split Dollar Life Insurance, in which an employee and employer agree to split the premiums payable on a life insurance policy, and to split the death proceeds. The formula for the split, and the ownership of any cash values in the policy over the respective contributions is contained in the agreement. There are no explicit income limits on split dollar programs.

Each of these programs creates a need for clear financial reporting to the participant as to the values and rights contained in the plans, and to the employer or sponsor for liabilities and exposures created. In many plans, the participant is able to select from recommended benchmarks or reference points for the crediting of values to his or her deferral account. The trend toward multiple allocations for the crediting of investment rates means the sponsor is required to track multiple reference points.

The sponsor may make hedging purchases (e.g., purchase of shares in an S&P 500 index mutual fund to informally fund an obligation to pay the employee a rate of interest corresponding to the growth in the S&P 500 index). In the case of the participant's account, it's just an IOU from the sponsor/employer. The employer may choose to informally fund a percentage or all of the expected liabilities for the plan, through acquisition of assets, either according to a predetermined schedule or based on payroll deferrals processed. In addition, the employer may informally fund the plan using investment vehicles that differ from the benchmarks selected by the employees. A plan sponsor may purchase life insurance policies on the lives of insured employees, with the sponsor as owner and beneficiary. The sponsor may use the death benefits to recover certain of its expenses in providing the Deferred Compensation (etc) program. The sponsor may also use cash values of the life insurance policies to assist in the payment of obligations.

In the past, the tasks of modeling the impact of an executive's participation in a program have been paper driven, with considerable interaction among a participant, an advisor, a plan sponsor, and the plan documents. This has slowed down the processing of transactions, and has slowed down reporting.

### SUMMARY OF THE INVENTION

One aspect of the invention is a browswer-based method, comprising the steps of: (a) receiving data relating to a non-qualified benefit plan from a participant in the non-qualified benefit plan, the data being input into a browser based application and transmitted over the Internet; (b) storing the data entered by the participant in a central plan database; and (c) making information from the central plan database available to a sponsor of the non-qualified benefit plan in real-time or near-real-time.

Another aspect of the invention is a method and system for administering a benefit plan for a sponsor. Data that have been input into a computer by a participant are received in the benefit plan. The data represent selection of a benefit choice by the participant. The benefit choice of the participant is implemented. Information is made available to the sponsor of the benefit plan in real-time or near-real-time. The information identifies a financial impact that the choice by the participant has on the sponsor.

### BRIEF DESCRIPTION OF THE DRAWINGS

FIG. 1 is a block diagram of a system for managing a benefits plan according to the present invention.

FIG. 2 is a block diagram showing the flow of web pages that can be visited and actions taken by a plan participant using the system of FIG. 1. The participant can move between pairs of pages that are connected by lines on FIG. 2.

FIG. 3 is a block diagram showing the flow of web pages that can be visited and actions taken by a plan sponsor and/or record keeper using the system of FIG. 1. The sponsor and/or record keeper can move between pairs of pages that are connected by lines on FIG. 3.

FIG. 4 is a diagram showing information inputs to and outputs from the database(s) of the system shown in FIG. 1.

FIG. 5 is a block diagram showing web pages for setting up a new plan.

FIG. 6 is a block diagram showing web pages for ongoing management of an established plan.

FIG. 7 is a diagram showing the difference between the architecture of the exemplary system.

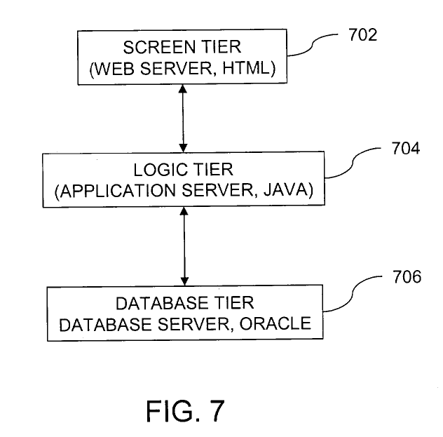

### GLOSSARY

Browser: An internet tool used to view and interact with various kinds of Internet resources (including hypertext documents) available on the World Wide Web. It may contain one or more calculation and access engines.

Deferral: An employee choice (“election”) to not receive compensation currently, choosing instead to leave it with the employer and collect interest based on a formula or hypothetical deemed investment option(s) on a tax-deferred basis.

Employee Benefit Liability. When the participant elects to defer receipt of compensation, an “IOU” from the employer is created. The participant does not control specific aggregate or individual assets which might be used to informally fund the plan.

Executive benefit plan: under current law, benefits-such as 401(k) and pensions may be limited for employees who earn more than a certain amount. To resolve these limits, some firms use nonqualified benefits to provide extra benefits to simulate the benefits of a 401(k) or pension plan for the limited employee. Examples include Supplemental Executive Pension Plan and Executive Deferred Compensation Plan.

NAV or net asset value: The value of one unit of deemed investment option, generally reported on a daily basis. Similar to the price of one share of a mutual fund. The NAV may be reported with or without investment manager expenses, and/or insurance company charges.

Nonqualified (NQ) benefit plan: A benefit or savings plan in which the sponsor is permitted to select who is covered, and for which benefits. The sponsor does not generally take a tax deduction until the benefit is actually provided to the participant, at which time the participant recognizes a tax liability. The SERP and Executive DCP are examples of NQ plans.

Oualified benefit plan: A benefit or savings program in which strict rules govern who is covered, the formula for benefits, and the security of assets. In general, the employer may take a tax deduction as contributions are made to the program, and, in general, the employee's account balance grows tax deferred until distributed from the plan. Examples include qualified pension plans, medical insurance, and 401 (k) plans.

Participant: the employee or executive covered in the plan. In many plan designs, the participant's choices of deemed investment options (benchmarks) or retirement dates drives the sponsor's liability forecasts.

Realignment: for a participant it is the process of moving his/her account values between available hypothetical deemed investment options (for example from a stock fund to a bond fund) to reflect a change in investment outlook. For a sponsor who is managing assets used to informally fund the plan, this is a change in asset investment mix typically for the purpose of matching a change in participant aggregate hypothetical deemed investment options.

Record Keeper. An administrative function which tracks change in deferral or other benefit obligations. May be internal to the Sponsor's business, or be provided by an outside firm, such as the Plan Administration Unit of the International Corporate Marketing Group

Sponsor: An entity, usually an employer, which offers the benefit program to employee participants. If an informal asset exists to offset some of the liability, it will usually belong to the benefit plan sponsor.

Web: As used here, refers to the Internet and to databases accessible via the Internet, or to web-like examples such as a thin-client implementation on an employer's own intranet, or an extranet.

### OVERVIEW

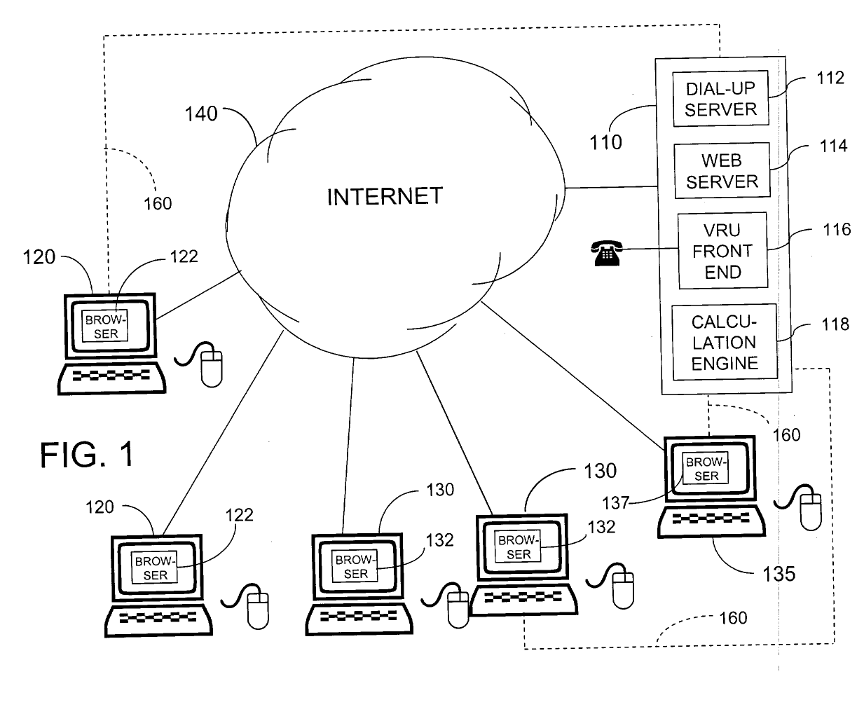

The present invention is a system 100 for managing a benefits plan. Preferably, system 100 is a browser based system using the Worldwide Web. FIG. 1 shows an equipment configuration that may be used to host browser based system 100. The exemplary system enables the employee/participant to enter personal and benchmark selection data which are matched to “rules” established on the browser based computer system by the employer/sponsor. The local browser is the portal to the system 100.

The exemplary browser based system 100 provides tools for an executive participant in the plan to consider possible plan change elections, and tools for the sponsor of the plan to be aware of the aggregate financial impacts of the participants' elections. The disclosed example is a browser based, Internet enabled computer system 100 that can be used to enroll participants who make compensation salary deferral elections on the system, and implement Executive Benefit, and other employee programs. This system 100 provides the plan sponsor with financial reporting information in real time or near real time. Previously, these benefit plans were administered through paper reports and phone interaction, or, by multiple steps or cycles of employee election, processing, and sponsor notification.

With the exemplary system 100, the participant is now able to enroll in the plan, perform research on the historical performance of plan accounts, monitor the choices previously made, and select a course of action almost instantly, or at the participant's own pace. System 100 allows the plan sponsor, usually an employer, to monitor the aggregate impact of participant decisions and consider multiple financing alternatives at the same time the employee is making the choices, and consult with an advisor.

With system 100, benefit related decisions are made and acknowledged immediately. The employer becomes aware of the financial consequences of independent employee decisions in real time or near real time.

The exemplary embodiment is a real time or near real-time financial reporting system. Unlike other systems, which only implement incremental changes to older paper-based systems, system 100 continuously monitors changes in benefit decisions and relates them to the employer's financial obligations. This differs from other systems, which have been designed to first serve the plan participant and then the employer.

System 100 is a huge advance over older systems where the information is stored in a static database, or on a mix of paper and computer files, and accessed by an analyst. In system 100, the human-machine interface program and calculation engine unify the multiple databases for sponsor, participant, account balance, and offsetting asset information, returning an integrated report with same time elements drawn from each.

The system described herein is able to accept data from employer payroll systems (such as deferral feeds) investment manager financial results, benchmark performance, and insurance company processing. This combination is unified by the human-machine interface program, and appears to be “one system” to the participant.

System 100 differs from paper-based systems, because it is continually responsive, updating the participant's selections, and the employer's potential liability in the same transaction. Each of these scenarios is aggregated and made available to the plan sponsor for an updated forecast.

FIG. 1 shows a hardware configuration of system 100. System 100 includes at least one host server processor 110, on which the software systems execute. Host processor 110 is accessible by a plurality of plan participants, using participant client computers 120 (referred to below as, “participants 120”), which may be general personal computers. If participants 120 access host server 110 via the internet, then each participant 120 is equipped with a web-browser, enabling the participants to interact with worldwide web pages and execute Java® applets. Alternatively, participants 120 may be provided access to server 110 via a proprietary computer network 160, for example, using a modem dial-up connection.

Server 110 is also accessible by a plurality of plan sponsors using sponsor client computers 130 (referred to below as “sponsors 130”), which may also be general personal computers. In a typical system 100, sponsors 130 include the same software and equipment as the participants 120. Access parameters in the record keeper's database allow the sponsors 130 to access global plan data (e.g., on sponsor web pages) that are not available to the participants.

Server 110 is also accessible by at least one record keeper (hereinafter referred to as the “record keeper 135”). The record keeper 135 may also have the same hardware and software configuration as participants 120 and sponsors 130, but record keeper 135 has read and write access to the system user access control files and to any data files that control the options that are available to the sponsors 130, participants 120 (and their advisors), as well as brokers, trustees, and institutional participants for the sponsor's plan. Thus, record keeper 135 can set the permissions that determine who can log into system 100 as a participant, and who can log into the system 100 as a sponsor, advisor, broker, trustee and institutional partner and what benefit options are displayed to participants and sponsors.

The record keeper 135 also has access to all of the functions and capabilities provided to the sponsors 130. This allows an employer to contract with the plan administration entity so that record keeper company personnel perform the sponsor activities on the system (e.g., inputting the deferral options, running reports on total sponsor liability, and the like). Alternatively, this capability also allows the employer to designate an employee to perform all of the administrative functions for the plan.

The exemplary browser based system 100 and its supporting Voice Response Unit (VRU) 150 can function from any 128 bit (or higher) encryption enabled Internet enabled computer in the world equipped with a browser, such as Microsoft Internet Explorer by Microsoft Corp. of Redmond, Wash. or Netscape Navigator by Netscape Communications Corporation, of Mountain View, Calif., and is intended to interact smoothly with the new generation of Personal Digital Assistants (Palm, etc) and Wireless Access Protocol (WAP) telephones. Nevertheless, the invention may also be practiced using other proprietary or non-proprietary network protocols, over other public and/or private computer networks. Further, although preferred embodiments include human-machine interface displays and applets that are capable of running in standard browsers, the invention may be practiced using native human machine interface applications that run directly under the host computers' operating systems (e.g., Windows®, UNIX, Apple™ OS and the like).

VRU 150 guides the participant to deferral plan balance amounts. The web-based system 100 provides a current alternative that supplants and may eventually replace the VRU 150 as a preferred means of communication with the participant who seeks immediate, real time access and execution. The expanded availability of internet enabled telephones is contemplated by the inventors.

System 100 permits an executive (or advisor) to review the deferral choices, current balances in deferral accounts as well as present value of SERP credits, if the SERP agreement permits that. Web-enabled system 100 expands this improvement to enable the executive to integrate those programs, and determine how much funding will be available from the various sources (SERP, deferral, etc), based on varying accumulation rates.

If the value of employer stock and options declines, the participant's retirement income shortfall may be picked up by deferral income or SERP distributions. System 100 also flags areas of concern on plan balances. If the plan sponsor chooses to maintain an insurance product, mutual fund account, or other financial instrument as an informally funded asset for the purpose of offsetting the liability, system 100 provides an interface to that informally funded asset. This continuous, integrated monitoring system provides reports for the sponsor's financial controls, on a frequency selected by the plan sponsor.

The unique combination of hardware (VRU, internal insurance databases, outside investment manager accounts) and software (unique benefit selection packages customized to each individual) in a single human-machine interface (e.g., the web-browser software) provides consistent asset/liability tracking for the employer.

This exemplary Web-based system 100 enables personalized, private financial choices for each participant, and may be initiated from any point in the world. This system is “self service” for the plan participant. This dramatically reduces the “pressure” some participants could feel when interviewed by a telephone based system. This system reduces the time required for an executive to consider, and select choices in personal benefit planning. Financial advisors who participate in the network will benefit from the integration.

This system communicates the aggregate results of all executives (as a group) to the sponsor. This system enables the employer to determine, if desired, in real time, any changes in benefit obligations and integrate them into the employer's financial reporting. This system enables an employer to determine, in real time, the benefit election decisions of its employees giving advance knowledge of elected deferral and realignments to be incurred in the future. This system enables the employer, if it is a bank or regulated financial institution, to provide financial data for inclusion in an OCC2000-23 (or similar regulatory directive) equity hedge compliance assertion.

This system can automatically track and, if necessary, make immediate distributions in the event of a hostile employer change if plan parameters provide by this circumstance for immediate vesting and distribution. With the exemplary system in place, the record keeper can direct payments to be made as soon as the trustee receives the funds (or control of an insurance plan owned by the employer) and instructs the record keeper to do so. Once employees begin to receive the payments under a previously contracted vesting schedule, it's much more difficult for the new owners to break the contract and stop payments.

Unlike traditional systems, the exemplary system software can enter separate web databases for continuous real time reference. At the conclusion of each business day, system 100 either extracts data from an insurance company's, mutual fund company's or trustee's database to update the value of the sponsor's plan assets offsetting any liabilities, or receives an FTP (or similar) “push” from insurance company, investment manager or trustee systems. Any asset used to informally find the plan can be fed into the system on a direct feed basis.

### DETAILED DESCRIPTION

### Establishment of Plan

A business recognizes that many of its employees are excluded from full participation in the company's 401(k) plan due to their status as highly compensated employees. (Highly compensated employees find their elective contributions limited to about 8%, rather than 14% or 15% of compensation permitted in most plans. This limitation avoids a finding that the 401(k) plan provides a disproportionate benefit to higher income participants, which is prohibited by law.)

The business, as plan sponsor, decides to offer a supplemental savings plan for these employees, with similar investment opportunities and similar company matching practices to the 401(k). Tax rules penalize either direct payments to the employees or irrevocable funding of the plans.

In a typical nonqualified plan, an employer and an employee agree on a future benefit promise in return for the employee's continued service. That promise becomes a liability to the employer as the benefit becomes a quantifiable amount, such as one year's salary, or an amount of money defined by the performance of a stock index, or the employee's vesting of certain interests. The liability is defined under Financial Accounting Standard (FAS) 87, Accounting for Pensions.

In the plan, the sponsor may take on obligations towards the participants. Some of these obligations are unilateral: e.g., the firm promises a pension contribution of $5,000 per year for each $100,000 of earned income in excess of $170,000, and agrees to attribute interest based on the 10 year Treasury bond to the annual accumulation. Other obligations are bilateral: e.g., an employee agrees to defer receipt of a portion of next year's compensation, and the employer agrees to credit benchmark rates of interest to the deferral allocation. The balance, including interest, is a liability to the employer.

There are three basic relationships in a nonqualified benefit agreement:

Between the participating employee and the employer/plan sponsor/administrator

Between the sponsor and its selected record keeping company

Between the record keeping plan administration company and the managers of informally funded assets underlying the benefit plan, if any

The business typically retains a plan record keeping company (such as the International Corporate Marketing Group of The Hartford) to provide the record keeping of the supplemental plan. ICMG's parent, Hartford Life Insurance Company, may manage life insurance policies or other assets underlying the benefit plan. This plan record keeping company services the plan by providing reports to the sponsors and participants, while managing the infrastructure.

Once the plan sponsor company selects the record keeping company, the record keeper can provide examples of system configurations that may be adopted by the sponsor. Preferably, these examples are in the form of one or more prototype applications having the look and feel of system 100 tailored by parameter selection to provide examples of different representative plans to demonstrate commonly selected plan options.

The sponsoring business chooses to allow participants to defer income into the plan based on a maximum percentage of total compensation (e.g., 15%) less the employee's actual deferral percentage to the 401(k) plan. In practice, this number is typically about 8% of compensation, but may change based on legislative or regulatory adjustments.

The sponsor of the plan determines rules, vesting, asset vehicles used to informally fund the plan, hypothetical deemed investment options to be used by participants for benchmarking interest crediting rates, and access rights that shape the choices available to participants.

The sponsor company defines to the plan record keeping company its choices for plan eligibility and features. At this time, the sponsor company may also identify the asset vehicles that will informally fund the plan.

Based on these inputs, the plan record keeper sets parameters in the system 100 to implement the desired rules and features. The determination of plan rules defines the choices participants will see. The sources of compensation available for deferral, allocation percentages which may be made to specific benchmarks, minimum and maximum deferral dollar or percentage limitations, and any withdrawal options are defined to system 100 as a unique property of this specific benefit plan. Even though there are numerous benchmarks available via the system 100, participants will be able to view only those selected by the plan sponsor as available for their participants and the available deferral sources.

With these relationships defined, the record keeping company implements the plan in a network-based system 100. The system 100 provides a single reference source capable of organizing, enrolling, and setting up insurance or other asset types used to informally fund the sponsor company's liabilities. Preferably, participants enroll using a self-service online program within system 100. The program verifies plan features and participant elections.

The same plan administration process provides content for the Voice Response Unit (VRU). By having a central, network based processing unit, consistent information is provided regardless of the access medium selected by the participant.

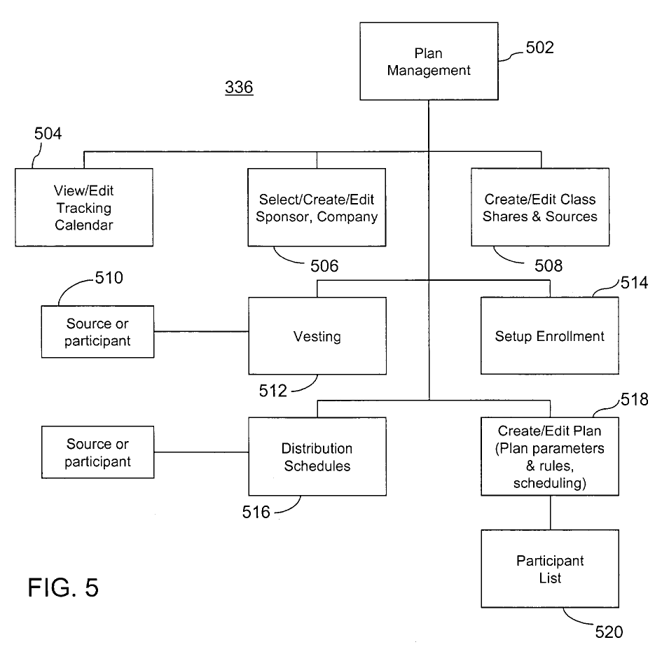

FIG. 5 is a block diagram of the plan management functions 336, provided entirely by the record keeper. Blocks may be updated based on plan rules and access protocols. In the exemplary embodiment, each block in FIG. 5 corresponds to a step or web page that is displayed to sponsor 130 or administrator 135, and into which sponsor 130 or administrator 135 may input data, selections of options, or requests for information. Generally, the lines in FIG. 5 represent two way paths between web pages connected by hyperlinks. Participants can link over from the page represented by any block in FIG. 5 to another page represented by the connected blocks above, below or beside that page in FIG. 5.

The plan management functions are entered via page 502. The plan management functions are mainly rules that are established by the plan's sponsor, and may be modified via the database, rather than solely through record keeper intervention.

At block 506, a page is provided to input the name and identification information (e.g., taxpayer identification no., state of incorporation, and the like) for the sponsor.

At block 508, a page is provided to input the rules controlling class share offerings, and the sources of funds for the class share programs.

At block 512, a page is provided for inputting rules for vesting in the plan. This includes an input page 510 or section of a page for including vesting rules based on source of the deferred income and/or the participant. These rules define, for example, the number of years a person has to work for the company before their contribution source (and applicable interest credits) vest, and what schedule is used to vest the source, i.e. 3 year cliff or 5 year step. Vesting schedules within a plan are tied to deferral sources and can be overridden at an individual participant level. Typically, different plan sponsors create different vesting schedules per plan

At block 514, a page is provided that controls the rules for enrollment. For example, enrollment may be limited to a number of most highly paid executives, or to a fraction of the employees making the most money. Enrollment screens are dynamically generated based upon plan parameters set within the system.

At block 516, a page is provided for setting the rules that govern distributions from the plan. The availability of a lump sum option or various options for payout over time, and the criteria for eligibility to begin distributions (e.g., minimum age, minimum/maximum holding periods, years of service, or employment through normal retirement) are decided.

At page 518, a page is provided for creating and editing the plan parameters.

At page 520, a page is provided for outputting a list of employees who are current participants in the plan.

In the exemplary plan administration method and system described in detail below, access is principally via the internet, providing global access from a variety of computer hardware platforms. Advantageously, the exemplary system 100 makes any transaction allowed by the plan sponsor self-service and visible on screen, with a confirmation generated and available via the web for viewing and printing.

### Participant Process

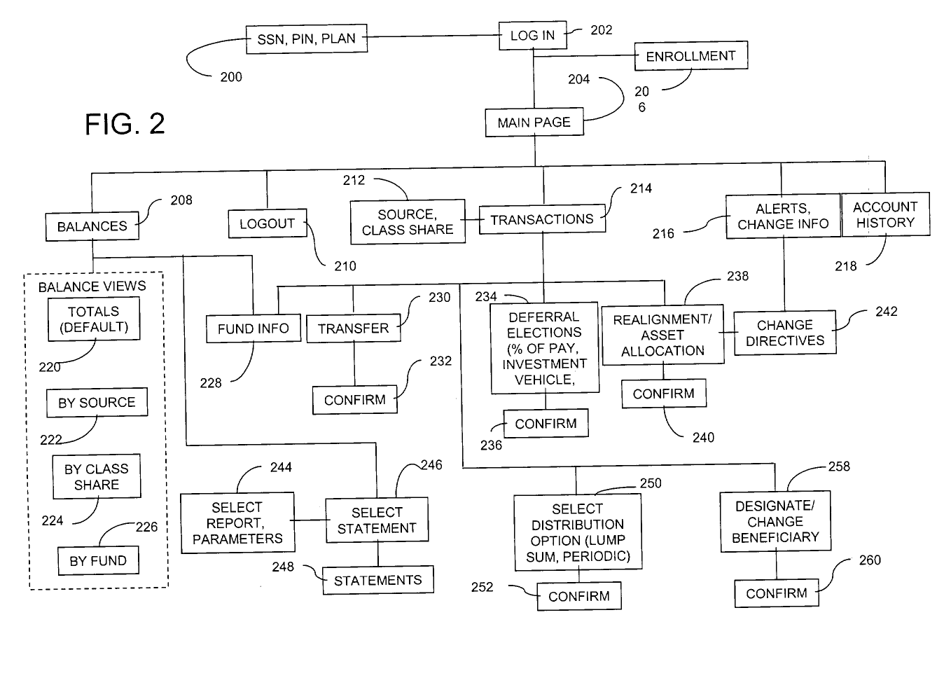

FIG. 2 is a block diagram showing the processes that are performed by participant 120 using system 100. In the exemplary embodiment, each block in FIG. 2 corresponds to a step or web page that is displayed to participant 120, and into which the employee may input data, selections of options, or requests for information. Generally, the lines in FIG. 2 represent two way paths between web pages connected by hyperlinks. Participant can link over from the page represented by any block in FIG. 2 to another page represented by the connected blocks above, below or beside that page in FIG. 2. Thus, blocks are interchangeably referred to herein as “pages.” It will be understood, however, that the blocks are not limited to web pages, and an alternative user interface may be substituted that does not use HTML or XML formats, and does not require a web browser.

At block 200, the employee participant is notified by the employer of inclusion in the program and given a web address to the plan record keeper website. Some participants 120 may belong to more than one plan with the same sponsor. For example, an executive may belong to a first plan that offers benefits to the sponsor's 100 most highly paid employees, and to a second plan that offers additional benefits to the sponsor's 10 most highly paid employees. At block 200, participant 120 inputs the plan to be accessed.

At block 202, participant 120 logs on to the website (or other appropriate network) and is asked to provide their date of birth, social security number, and year of hire (Three Factor Authentication). Participant station 120 only displays plan details appropriate to this specific employee's plan participation.

At block 206, the first time the employee logs into the system 100, the system 100 verifies the Three Factor Authentication against information provided by the Plan Sponsor. Participant 120 selects a PIN, providing required information to the system. At this point, the employee is advised of the terms and conditions of the plan and is required to accept the conditions (including electronic signature) in order to proceed further with the electronic enrollment process including confirmation of personal information and selecting a plan beneficiary(ies), providing necessary information as applicable. The electronic enrollment process includes all of the information typically provided by an employee enrolling in a paper-based benefits system. (An optional alternate paper enrollment procedure may be made available. If the participant employee elects the alternate enrollment process, he or she may print out the materials, make the elections, and mail or fax them to the designated person, who enters them into system 100, and sends a confirmation form.) In addition, participant 120 can input additional parameters that are useful in system 100, that were not relevant in paper-based systems. For example, participant may be given options to receive periodic reports via electronic mail, and/or to receive alerts of plan changes and important events via electronic mail.

At block 204, after the participant employee is enrolled and the enrollment period has terminated participant 120 is taken to the main web page upon each subsequent successful login. The main web page provides general information and hyperlinks to a plurality of pages, including specific pages for viewing balances, logout, participant transactions, alerts, and account history.

At block 208, participant 120 enters a balance reporting page. Preferably, this page provides participant 120 a plurality of hyperlinks to access respective pages for a variety of report formats and contents. For example, if the link for page 220 is selected system 100 may report the total(s) of all plan balances relative to that participant. If the link for page 222 is selected, system 100 may report the funds broken out by source (e.g., new contributions, various source contributions, distributions, and earnings). If the link for page 224 is selected, system 100 may report the funds broken out by class share account (discussed below). If the link for page 226 is selected, system 100 may report the funds broken out by fund (benchmark). In addition to being able to view balances, page 208 provides a link to fund information page 228.

At block 228, participant 120 views fund information. Participant 120 considers and researches available funds. From the fund information page 228, participant 120 can either return to the balance views page 208, proceed to one of the specific balance views 220-226, or hyperlink to one of the transaction pages.

From balances page 208, participant 120 can also hyperlink to a reports section page 246. At block 246, participant 120 views a plurality of statements from which to choose. At page 248 the statements are displayed and/or printed. Participants are able to print out reports on line. These may include, for example the transaction history for the last three months or six months, the balance in his or her account at the time of the query compared to the beginning of the year.

At block 216, system 100 provides a “tickler” feature to alert a participant to the fact that a class share is about to freeze and they will not be able to defer into that class share in the upcoming enrollment. The system provides the record keeper with the ability to alert participants and plan sponsors on a plan level using a plan message with regard to changes, etc. By logging on to the site, a participant can retrieve information with regard to a distribution schedule and make changes based upon plan parameters set by the sponsor.

At block 218, participant 120 can review and research all financial transactions affecting their account through the account history screen. This allows the participant to view when deferrals were credited to the account as well as any realignment, distribution and enrollment activity.

Block 214 provides the main path for executing transactions on system 100. At block 214 participant 120 views a page with general information and a plurality of hyperlinks to specific pages for source class share selection, fund information, asset transfers, deferral elections, asset allocation and realignment, selecting distribution options, and designating or changing a beneficiary.

At block 234, participant at enrollment sees previously elected deferral allocations (stocks, bonds, specific subcategories) and/or specific investment vehicles. Participant 120 selects the deferral amount desired (system 100 calculates elective limits information, and adjusts allowable deferral) and identifies either retirement account or class share account.

The participant may chose to have his or her deferrals and any company match credited with a hypothetical interest rate based on benchmarks such as the “S&P 500®” Index return, or on the interest rates of certain government securities, or another acceptable index or publicly traded securities. The plan record keeper administers the “self service” web-site on which the participant 120 elects the sources and amounts to defer (as allowed by plan parameters), selects the benchmark allocations desired by class share (distribution bucket), and researches benchmark performance through the plan library. The sponsor can download participant deferral elections through a file generated by system 100 for payroll processing. After processing the payroll, the deferral file is uploaded via the internet to the server 110.

When the participant makes a deferral election, the system implements the transaction by issuing a file summary which the sponsor applies to the payroll processing system to withhold a portion of the participant's income, and the appropriate account entries are set up for the participant.

At block 236, a confirmation page is displayed. Participant 120 receives immediate, online confirmation of plan elections followed by a confirmation in the manner selected by the plan sponsor.

At block 212, the participant 120 at enrollment makes class share elections for each deferral source. A class share (or specific year) account is a sub-account held for the benefit of the participant that is used to separately track participant deferrals and interest credits on those deferrals for the purpose of distributing separately from all other deferrals (and interest credits) within the participant's account. Class shares are managed separately by the participant and are used to elect distribution timing for all amounts within the account (e.g., before or at/after retirement) including 1) a participant-elected start date, 2) paid either over a participant elected number of years or at a participant elected amount until the account is completed distributed. A participant employee may have separate class share accounts established for each year of participation in the plan. The updated obligation is displayed to the plan sponsor, which carries the deferral and any hypothetical gains as a liability. The obligation is updated based on the daily interest credit from the reference benchmarks selected, by a system review of the appropriate benchmarks, and assumption into the browser. The selection is confirmed to the participant.

At block 230, participant 120 is provided the option to rebalance or realign allocations among various investment benchmarks, including funds and/or stocks. At block 232, any instructions to rebalance or realign allocations are acknowledged.

When the participant makes a transaction (e.g., deferral election, realignment, distribution or change of beneficiary), the participant's decision is automatically implemented, to the extent allowed by law. In the case of a transfer (block 230), implementation involves determining the value of the “transferred balance” on the day in which the transfer occurs based on the old benchmark rate, and changing the benchmark applied to that value. Because the sponsor does not necessarily hold a specific asset informally covering the portion of the participant's account that is “transferred”, implementation does not require the sponsor (or record keeper) to actually transfer an asset used to informally fund the plan in a hedging transaction. The sponsor (or properly authorized record keeper) may optionally do so.

At block 238, participant 120 can view a page to choose a new benchmark allocation. Participant 120 can also choose to re-allocate balances or re-align objectives. System 100 displays only finds and allocations approved by plan sponsor for participant's level. For example, the sponsor company may decide that participants 120 must allocate 40% of their account to benchmarks which guarantee preservation of principal, or sponsor may decide that participants are not permitted to allocate 100% of their account to any single benchmark. Record keeper 135 would configure system 100 so that, from the allocation realignment page 238, only permitted allocation options are presented. Page 238 may include an option whereby, if the participant 120 has previously made an allocation, the participant can select the option of re-balancing his/her account among the same benchmarks, to restore the previously selected allocation.

At block 240, participant 120 receives new, online confirmation of all allocation change requests.

At block 250, participant 120 at enrollment chooses when to begin distribution and the number of payments (as permitted by plan rules). Web page 358 of system 100 offers a range of choices, such as lump sum distributions, annual payments for a fixed period of time or fixed payments until account is empty. If permitted by plan rules, the participant by change this election prior to the commencement of the benefit payment.

When the participant elects to begin distributions (block 250), the participant's electronic request is received by the distribution engine, which checks the unit values to assure sufficient value (and/or vesting) exists to execute the transaction. If value exists, a transaction order is created and executed, followed by a confirmation to the participant of the distribution schedule, and a notice to the sponsor.

At block 252, participant 120 receives confirmation of planned distributions online. These distributions are communicated to the Plan Sponsor for processing. Subsequently, the participant employee receives the distribution via the elected means.

At block 258, participant 120 can designate or change the primary and/or contingent beneficiary of the benefits in the plan. This can be performed either while the participant is still an employee, or afterwards, during retirement. At block 260, the designation or change of beneficiary is confirmed by the system 100. If the participant employee/retiree dies prior to distributing all of his or her account balance, final distributions are made to the beneficiaries according to plan rules.

Although a single logout block 210 is shown in FIG. 2, a logout field is provided that is visible on all pages of system 100, so that the user can log out at any time without backtracking all the way to the main page 204.

The system 100 offers multiple degrees of access, tailored to each participant 120, and various levels within the sponsor's management. Thus, the employer may offer a first package to the 100 most highly paid employees, and a second additional package to the 10 most highly paid employees. In personalized materials, participants 120 are issued an access code and may select a PIN. The code enables the individual to confirm personal information provided by the sponsor 130, input changes, review investment materials, view balances, realign investment allocations to benchmarks, select distribution options, and designate a beneficiary for plan benefits. A plan sponsor or trustee may permit variations on levels of access to conform to plan provisions.

### Sponsor/Administrator Process

Given the deferral elections by all the participants, the plan administration company obtains an analysis of the participant deferrals from the system 100, suggests an allocation for any assets used to informally fund and offset participant liabilities, and (optionally) provides the sponsor with information on existing assets used to informally finance the liabilities that become due upon distribution of participant accounts including termination or death. (The sponsor can buy insurance policies or some other asset (e.g., mutual funds) to informally offset the liability owed to participants.) System 100 provides aggregate balances for assets used to informally fund the plan (for example cash value of any life insurance) as well as detailed liabilities for the sponsor for financial reporting purposes.

One skilled in the art understands that any assets purchased by the sponsor for the purpose of informally funding the plan may, but need not, be of the same type as the benchmarks offered to employees (e.g., an S&P 500 index mutual fund used to offset liabilities to employees who elect an S&P 500 index benchmark) or a completely different asset (e.g., a bond fund to offset liability for employees who elect an S&P 500 stock index benchmark). In some cases, the plan is not perfectly matched in liability amount or duration; the sponsor makes its payouts out of the available assets used to informally fund the plan at the time payout is due. The sponsor may do so to prevent the Internal Revenue Service from asserting that the participant has constructively received the funds prior to actual benefits distribution. This ensures that the benefits are not taxed to the participant as current income. The exemplary system supports all of the above methods of administering the plan.

Thereafter, the system 100 changes employee benchmark allocations by direction of the employee and updates balances based on benchmark fluctuation, distributions, deferrals, etc. Any time a proposed change is input, system 100 automatically verifies that plan rules are not violated by any change. Participants are provided individual reports of their balances in the plans. These changes are also incorporated into the total sponsor liability records in real time and can be reported to the sponsor on a daily basis. System 100 provides data that a sponsor uses to determine whether or not to reallocate its informally funded assets to reflect the aggregate allocation of the sponsor's liabilities.

Employers log on to the website to retrieve notices provided by the System. These notices may include, for example, notices that more money is required in the offsetting account, or that a transaction is due. The system tracks transactions and maintains receipts for such activity.

For example, assume a participant elects to participate in the deferral plan, and defer 10% of his/her pay in return for the employer's promise of a 3% match plus the Standard & Poor's return. To implement the participant's choices, Payroll needs to withhold 10% out of the participant's pay and provide a deferral file to the record keeper which indicates that 10% has been deferred and at the same time notify the employer that the plan liability balance has grown (the system will show an increased liability and the transaction receipt for sponsor viewing) and that the employer now has 10% of the participant's pay available for the unrestricted use of the corporation. The system 100 records those transaction entries; the participant's deferral election, the payroll deduction and the increase in Plan liabilities.

When a participant seeks a distribution of assets, the self-service system 100 provides distribution options (e.g., lump sum, fixed stream of payments, or the like) and available sources (assets). The participant's selection is stored on system 100. The record keeper advises the sponsor of distributions due. The sponsor determines which assets to use to pay the liability.

The exemplary embodiment is a unified system, which simplifies the interactions among participants, sponsor and administrator. In system 100, the employer makes certain information available to system 100, including employee salary and bonus, age, sex, managerial level, expected retirement age and certain plan parameters. System 100 is set up so that each employee participant 120 has access only to his or her individual data. The employer or sponsor 130 has access to the aggregate of employee decisions and the daily changes, based on the benchmarks selected.

In the context of plan record keeping, the system calculating engine 110 is the core resource, providing the means to process data stored in or generated by several different databases and report generators. Each sponsor 130 has a unique series of outputs from a common processing mechanism.

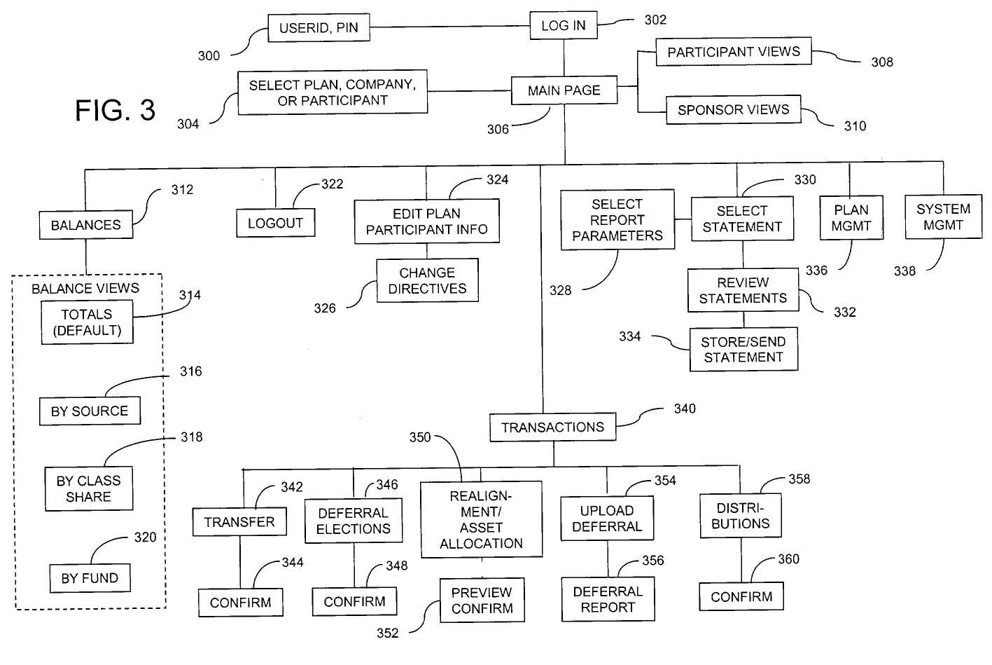

FIG. 3 is a diagram showing the processes and web pages that can be accessed by sponsors 130 and/or record keepers 135. The exemplary system is designed to provide flexibility in the allocation of responsibilities between the sponsor and the record keeper, so that experienced personnel at either entity can perform any or all of the functions. The ability to perform functions is limited by user designations (Administrator, Sponsor, Participant). Thus, in the description below, certain tasks are described as being performed by the sponsor 130 and other tasks are described as being performed by the record keeper 135. This is only an example of one allocation of responsibilities. The system supports any allocation authorized by the sponsor.

The look and feel of the sponsor web pages may be similar to that of the participant pages described above with respect to FIG. 2. Because the exemplary embodiment is a supplemental benefits system for executives, some of the individuals who are participant employees may also have access to the sponsor pages. Thus, at blocks 300 and 302, the login process is similar to that described above with reference to the participant 120 of FIG. 2. In the case of a participant who is also authorized to view the sponsor pages, the main web page 306 gives the user an option to visit the “select user type” page 304. Page 304 allows the user to select either participant views 308 (which causes sponsor host 130 to hyperlink to the web page 204 of FIG. 2) or sponsor pages 310, described below.

In an exemplary arrangement, on a day to day basis, the employer expects the record keeper company to use the system to manage the plan, including, for example, maintaining the records, monitoring the employees who access the site; observing whether the employees have problems or questions, determining what accounts are being used, determining whether there is a movement by participants between benchmarks, and determining whether the employer's informally funded asset allocation has migrated from its target, due to change in aggregate participant values. For example, the sponsor may determine that participants have 75% of their deferred compensation earmarked for fixed income security benchmarks, while it only has 50% of its informally funded assets in fixed income security funds.

On the other hand, in this exemplary arrangement, the employer 130 typically can look for daily monitoring. For example, the employer may use the system to determine how many benefit election changes were made by employees and whether there has been any significant change in deferral balances. Also, the employer typically uses the system to audit the activities of system 100.

Several of the sponsor pages shown in FIG. 3 provide aggregated versions of the outputs provided in the participant pages described above with reference to FIG. 2. For example, within the balance view pages 312, the totals page 314 provides the grand total for the company, summing all the individual totals shown to individual participants in web page 220. The source page 316 provides a listing of the totals for all participant employees by source, summing the individual values shown to a respective participant in web page 222. The class share page 318 provides a listing of the totals for each class share, where each total the sum of the values shown to respective participants in web page 224. The fund page 320 provides a listing of the totals for all participant employees by fund, summing the individual values shown to a respective participant in web page 226. Thus, pages 312, 314, 316, 318 and 320 provide the employer or administrator with an up-to-date view of the aggregate liability of the plan.

At block 330, sponsor 130 can request reports. Plan reports are generated either from a schedule, or upon request. They may be viewed on paper or on screen. Most reports are based on previous selections and arrangements of information, organized in a consistent manner, as authorized by the sponsor. The statement blocks 330, 332, 334 and 338 are analogous to the statement blocks 244, 246 and 248 of FIG. 2, but provide aggregate statements for the plan as a whole, instead of individual statements. Therefore, a detailed description of these pages is not required.

In addition to the liability statements summarizing the deferred compensation by participants and obligations, based on the benchmarks, system 100 tracks the liability and values it daily. Assets used to informally fund the plan may be updated daily through electronic means or updated on a non-daily basis manually. The record keeper accesses the daily values of the accounts via system 100, using feeds from sources such as Bloomberg, Bisys, and Hartford. These assets may be viewed in a variety of formats. For example, the sponsor/administrator may view the total value of each benchmark held, or the investments purchased to informally fund a particular type of liability (e.g., total value of informally funded assets supporting the obligations to make payments based on an S&P 500 benchmark).

Block 340 is the main transactions page. The sponsor may own certain accounts which informally offset some or all of the plan obligation due the participants. These accounts may include employer owned mutual funds, company stock, life insurance on the lives of the participants, or other assets. Thus, sponsor 130 has access to investment decision pages that are analogous to the transaction pages provided for participants.

At block 346, system 100 controls the deferral elections available to participants. For example the plan may set a minimum and/or maximum fraction of the participant's deferred compensation to be invested in any one benchmark (e.g., at least 5% or at least 10% of the participant's total deferral amount going to a particular benchmark or at most 40% going to any one benchmark). Once such a rule is established, the system will not permit a participant to designate an amount below the minimum or above the maximum as applicable, and instantly advises the participant when the he or she tries to do so. The minimum percentage is advantageous from an administrative standpoint, because it creates slightly larger balances in the investment accounts and at the same time reduces the total number of choices for each individual participant. This increases the variance of the amounts invested in each individual benchmark. The sponsor can use the system to easily determine which benchmarks failed to attract significant interest among participants, and can simplify operation of the plan by dropping such benchmarks.

At block 350, the sponsor 130 can realign any assets that have been set aside to pay the liabilities associated with the employees' deferrals. The system allows the sponsor to deliberately choose an asset allocation that differs from the grouping of benchmarks selected by the participants; the sponsor may choose to purchase more (or fewer) equities than the allocation of benchmarks chosen by participants for their deferrals. Preferably, an alternative option is provided by which sponsor 130 can choose to automatically realign the sponsor's assets periodically, so that the sponsors' allocation approximately matches the aggregate allocation of assets from all of the employees' selected benchmarks in the plan. At block 352, sponsor 130 At block 350, the record keeper 135 can direct the realignment of any participant accounts. At block 352, the record keeper 135 can preview the changes from such a realignment before actually authorizing completion of the transaction. If completion is authorized, a confirmation is provided at page 352. The system 100 permits an automatic delegation of realignment functions from the participant. Subject to plan rules, the system may permit a periodic (end of year, etc) adjustment of deferral balances to maintain a pre-determined ratio, such as 70% stocks and 30% fixed income.

On behalf of the sponsor, the record keeper may monitor the assets used to informally fund the plan. In these situations, the human-machine interface application of the plan record keeper host 135 accesses information stored on databases, which receive regular feeds from the other providers (fund managers, insurance companies, trustees, etc).

At block 354, sponsor 130 uploads the deferral information indicating participant deferral transactions to the system. In one variation of the exemplary embodiment, the transactions are batched and uploaded to the system at the end of the day. In another variation of the exemplary embodiment, the transactions are individually loaded in real-time or near real-time each time a participant selects a deferral option, distribution, or realignment.

At block 356, sponsor 130/record keeper 135 can view a report of all transactions in the plan. For a batch system, the sponsor/record keeper can obtain a report of the transactions uploaded for the current day. In a real-time or near-real time system, a view or report may contain all transactions thus far entered during the current day, or all transactions from the inception of the plan. Alternatively, both real-time and batch systems may allow the sponsor/record keeper to obtain a deferral report covering all deferrals in the plan since the beginning of the plan.

At block 358, the sponsor can view the current distributions that are required to be paid to individual participants. The source of assets earmarked to fund distributions is determined by the plan sponsor (mutual funds, withdrawals of life insurance values, direct payment by sponsor, etc.). Typically, the sponsor prints out the list of current distributions and either the sponsor or a trustee cuts distribution checks, or makes electronic funds transfers as provided by plan provisions, to make the necessary payments. At block 360, the sponsor receives confirmation of distributions processed on system 100 as well as updated reports of distributions to be made.

The pattern of distributions continues for the term elected by the participant, as defined by the choices offered under plan rules and vesting schedules.

At step 364, the sponsor is provided an insurance option for financing the plan. If the employer invests in a cash value life insurance contract, which the employer owns and for which the employer is the beneficiary, the income inside the life insurance policy is tax deferred to the employer. When the employee dies, the death benefits are paid to the employer tax-free. An employer insuring two or three people typically would not want to rely on death benefits to fund the plan. If, on the other hand, a sponsor has 1,000 employees, and has a predictable stream of retirements the plan sponsor might expect to receive several death benefit payments in any given year; the sponsor could take withdrawals from some of the insurance policies, and otherwise raise enough funds to pay the benefits, and keep most of the policies in force. The exemplary system provides the ability for the sponsor to simplify the process of obtaining the insurance, tracking the insurance assets, and obtaining funds by cashing in, collecting proceeds from, or borrowing against the policies. At step 364, the sponsor may access a self service library including information relating to the plan such as the Plan document and participant communication.

If the plan sponsor has purchased life insurance on the life of the plan participant, it may choose to finance some of the benefit distributions through withdrawals of cash values from the insurance contract. The life insurance processing system provides a regular feed of sponsor owned asset values to the human-machine interface of the sponsor host computer 130.

The processing of sponsor-owned life insurance policy cash values is not done by the plan administrator 135, even if the record keeper company is in the life insurance business. The life insurance company does not have access to individual participant deferral information. Other functions of the life insurance processing entity include calculations of costs of insurance provided, surrender values, daily interest credit to policy investment values, and death benefit payable. The human-machine interface application of the record keeper host 135 accesses these outputs in a separate database to verify unit value amounts prior to disbursing a distribution to the plan sponsor.

The plan record keeper may review insurance policy investment values and interest credits prior to the disbursement of participant benefit payments.

At block 366, if benefit plan rules permit, loans against, or withdrawals of, plan values may be made. In this situation, a transaction is made, the plan balance is checked by the human-machine interface application of the plan administration host 135, and a distribution authorized.

System 100 also supports a tickler system via electronic mail message or an instant messaging for sponsors, participants and record keepers.

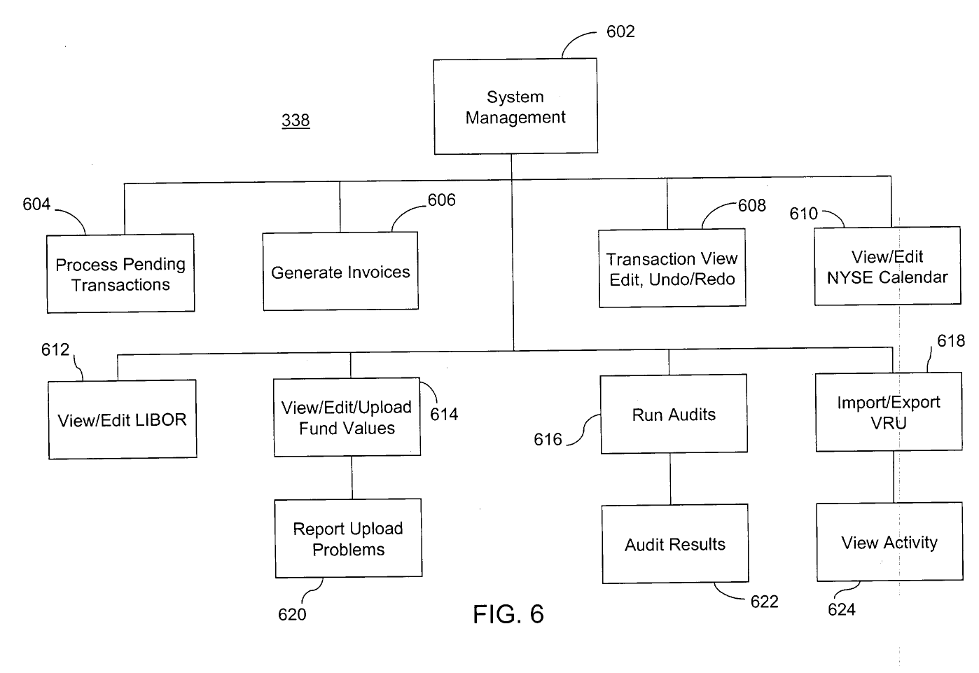

FIG. 6 is a block diagram showing the various system management functions (which may be implemented in respective web pages or other data entry graphical user interface).

Upon entry into the system management page 602, the administrator is provided links to pages 604-624.

At block 604, the pending transactions (transactions that have been requested but not yet processed based upon an overnight batch process schedule or a plan scheduling limitation) can be forced through the system by the record keeper 135 as authorized by the sponsor. An example would be a participant initiated request that came in over the weekend. During the day on Monday, the system 100 immediately sets it up for Monday's night's batch process but the record keeper could “force” the transaction through using block 604 prior to the scheduled batch process.

At block 606, the administrator is provided the optional capability to generate invoices to the sponsor for use of the service.

Block 608 provides a mechanism by which transactions can be viewed, changed, undone and reprocessed as requested by a sponsor. For example, the sponsor may have processed a deferral file that had incorrect amounts for one or more participants. Using block 608, the record keeper can undo the deferral transaction, correct the amounts as needed and re-process.

At block 610, the record keeper can view the New York Stock Exchange calendar. For plan transactions that are requested on a “closed” day, system 100 can be programmed on a plan by plan basis to either process based upon the previous day's close price or the next available close price.

At block 614, fund values are uploaded to the system. For example, service such as Bloomberg may provide all of the NAV's for a sponsor's benchmarks.

At block 622, the record keeper 135 is provided tools to audit the management of the plan. Preferably, the audit process is automated.

The ability to view the aggregate assets used to informally fund the plan also gives the sponsor the ability to rapidly check those balances as an additional control, to prevent unauthorized withdrawals of the assets.

At block 618, the system can import data from two additional sources: manual entry and an optional insurance company policy value system. The participant, can call up or log on to the internet and call up the VRU to verify transactions. The participant logs in, provides a password and ID code, and the system is able to provide the account balance as of the last update, the date of the last transaction and other information.

### Data flow

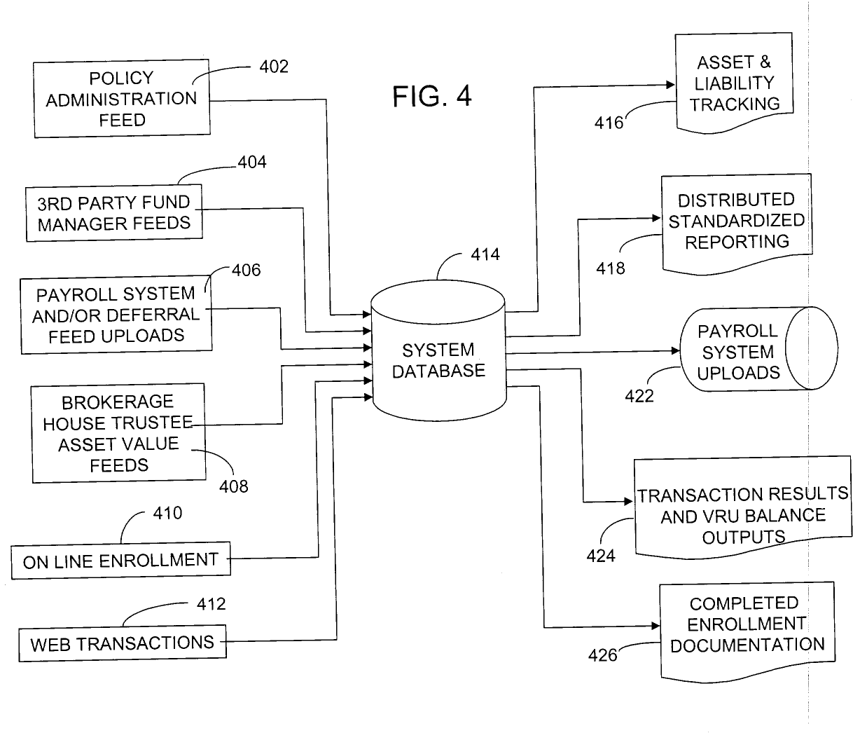

FIG. 4 is a data flow diagram showing various inputs and outputs of system 100. Block 402 includes a plurality of data entered by the system record keeper, defining the rules and parameters for a given plan. Block 404 provides access to data received from external sources indicating the NAV for funds, including dividend, capital gain and stock split activity. The system 100 can be set up to track various daily valued hypothetical deemed investment options for participant accounts including but not limited to mutual funds, stocks, bonds, variable and fixed interest rate investment products. Block 406 includes data received from payroll indicating the actual amounts deferred from participants' pay. Block 408 includes data received from brokerage houses, trustees, etc. relating to the values of specific assets that may be used by the sponsor to informally fund the plan. Block 410 includes the various data entered by participants during online enrollment. Block 412 includes transactions containing instructions from participants (for example, entered via the web browser interface 122).

All of the above data from blocks 402, 404, 406, 408, 410 and 412 are obtained independently by system 100 from the various sources and may be stored in a single system database 414 that is continuously updated to maintain coherency with the data of the sources.

FIG. 4 also shows various outputs provided by system 100, either according to a schedule or upon request. Block 416 indicates various specific queries that may be entered by a user for tracking a specific asset and liability. Block 418 includes a plurality of standardized reports that are generated and distributed by system 100. Block 422 includes data sent to payroll, for example to implement changes in participants' deferral elections. Block 424 includes the confirmations of transaction results and any outputs provided by way of VRU 116. Block 426 includes completed enrollment documentation that is provided to the participants/sponsors/record keepers based on the elections made by participants during the online enrollment process.

Although the exemplary embodiment includes desktop computers, activities of participants 120 and sponsors 130, such as communicating and changing elections, allocations and the like, using web enabled phones and Personal Digital Appliances (PDA) are contemplated.

Although system 100 is preferably a self-service system, it is contemplated that Instant Messaging to a live account representative will be available to sponsors 130 as an alternative to the internet or VRU contact.

The present invention may be embodied in the form of computer implemented processes and apparatus for practicing those processes. The present invention may also be embodied in the form of computer program code embodied in tangible media, such as floppy diskettes, read only memories (ROMs), CD ROMs, hard disk drives, ZIP™ drives, or any other computer readable storage medium, wherein, when the computer program code is loaded into and executed by a computer, or computer internet browser, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code or access protocols, including passwords, etc is loaded into and executed by a computer, the computer becomes an apparatus for practicing the invention. When implemented on a general purpose processor, the computer program code segments configure the processor to create specific logic circuits. The present invention may also be accessible, in whole or in part, on the record keeper's own computer system and servers, or may be located, in whole or in part, on the sponsor's computer systems, including thin-client intranet applications or browsers.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A browser based method, comprising the steps of:
(a) receiving data relating to a non-qualified benefit plan from a participant in the non-qualified benefit plan, the data being input into a browser based application and transmitted over the Internet or an intranet of a sponsor of the non-qualified benefit plan;
(b) storing the data entered by the participant in a central plan database; and
(c) making information from the central plan database available to the sponsor via the Internet or intranet.

2. The method of claim 1, wherein step (c) includes making information from the central plan database available to the sponsor in real-time or near-real-time in response to receipt of data in step (a).

3. The method of claim 1, further comprising drawing additional data into the central plan database from a plurality of additional databases.

4. The method of claim 2, further comprising organizing the additional data drawn from the plurality of additional databases.

5. A method for administering a benefit plan for a sponsor, comprising the steps of:
(a) receiving data input into a computer by a participant in the benefit plan, the data representing selection of a benefit choice by the participant;
(b) implementing the benefit choice of the participant; and
(c) making information available to the sponsor of the benefit plan in real-time or near-real-time, the information identifying a financial impact that the choice by the participant has on the sponsor.

6. The method of claim 4, wherein step (a) includes receiving benefit choice data from a plurality of participants, and the information of step (c) identifies an aggregate financial impact of the choices by the plurality of participants.

7. The method of claim 6, further comprising the steps of:
notifying the sponsor when an imbalance exists between assets used to informally fund a plan and an aggregate of participant accounts, or when a predetermined threshold variance is exceeded; and
providing information that is used to change an asset allocation of informally funded assets based on an aggregate allocation of participant accounts after step (c).

8. The method of claim 6, wherein the benefit choice includes a selection of at least one of the group consisting of a fraction of gross pay to be contributed by the participant, benchmark allocations to be used for tracking hypothetical gains/losses of participant accounts, distribution option(s), and a designation of a beneficiary.

9. The method of claim 8, wherein the benefit choice includes a selection of a distribution option from the group consisting of a lump sum distribution and a series of periodic or equal payments.

10. The method of claim 5, further comprising a means for causing investment materials or an account balance to be displayed to the participant.

11. The method of claim 5, further comprising a means for displaying a plurality of alternative methods that the sponsor can use to informally fund participant distributions.

12. The method of claim 5, further comprising a means for alerting the participant to an expected or an unexpected event.

13. The method of claim 5, further comprising the step of displaying a plurality of alternative benchmarks for which the participant can elect to allocate his or her account balance(s).

14. The method of claim 12, wherein the expected event is a distribution required due to a previously recorded participant election or a plan rule such as the participant reach age 65.

15. The method of claim 12, wherein the expected event is a purchase by the sponsor of an insurance policy on the life of the participant.

16. The method of claim 15, further comprising initiating withdrawals against a cash value of the insurance policy to finance a distribution of assets to the participant.

17. The method of claim 5, wherein the data are received by way of the Internet.

18. The method of claim 5, wherein the data are received from a web browser-based application program.

19. A system for administering a benefit plan for a sponsor, comprising:
(a) means for receiving data input into a computer by a participant in the benefit plan, the data representing selection of a benefit choice by the participant;
(b) means for implementing the benefit choice of the participant; and
(c) information means for making information available to the sponsor of the benefit plan in real-time or near-real-time, the information identifying a financial impact that the choice by the participant has on the sponsor.

20. The system of claim 19, wherein the receiving means receives benefit choice data from a plurality of participants, and the information means identifies an aggregate financial impact of the choices by the plurality of participants.

21. The system of claim 20, further comprising:
means for alerting the sponsor of an under-weighted or over-weighted asset condition relative to a set of participant deferral allocations; and
means for changing an allocation of assets used to informally fund a plan based on the aggregate allocation of benchmarks within participant accounts.

22. The system of claim 20, wherein the benefit choice includes a selection of at least one of the group consisting of a fraction of gross pay to be contributed by the participant, benchmark allocations to be used for tracking hypothetical gains/losses of participant accounts, distribution option(s), and a designation of a beneficiary.

23. The system of claim 22, wherein the benefit choice includes a selection of a distribution option from the group consisting of a lump sum distribution and a series of periodic or equal payments.

24. The system of claim 19, further comprising a means for causing investment materials or an account balance to be displayed to the participant.

25. The system of claim 19, further comprising a means for displaying a plurality of alternative methods that the sponsor can use to informally fund participant distributions.

26. The system of claim 19, further comprising a means for alerting the participant to an expected event.

27. The system of claim 26, further comprising means for alerting the participant to a temporary or permanent change in allocation or realignment or deferral opportunity.

28. The system of claim 27, wherein the change in allocation or realignment or deferral opportunity is caused by an “employer blackout period” or an annual enrollment event.

29. The system of claim 26, wherein the unexpected event is a revision of a benchmark used by the participant.

30. The system of claim 26, wherein the expected event is a distribution required due to a previously recorded participant election or a plan rule such as the participant reach age 65.

31. The system of claim 26, wherein the expected event is a purchase by the sponsor of an insurance policy on the life of the participant.

32. The system of claim 31, further comprising means for initiating withdrawals against a cash value of the insurance policy to finance a distribution of assets to the participant.

33. The system of claim 31 wherein death proceeds are used by the employer to defray costs of providing benefits and administration services.

34. The system of claim 19, wherein the data are received by way of the Internet.

35. The system of claim 19, wherein the data are received from a web browser-based application program.

36. The system of claim 35, wherein the application program is a thin-client intranet application accessible to a sponsor's computer system.

37. A system for administering a benefit plan, comprising:
a plurality of databases, collectively containing data related to pay and deferred pay of a participant in the plan and benchmark results for the participant; and
at least one computer on which a browser-based program is executed, the browser-based program being capable of accessing any of the plurality of databases.

38. The system of claim 37, wherein the plurality of databases include an insurance policy database having insurance information related to plan participants.

39. The system of claim 37, wherein the browser-based program accesses data from the plurality of databases in real time or near-real time.

40. The system of claim 37, wherein the browser-based program includes means for prompting the participant to input a selection of a benefit choice.

41. The system of claim 40, further comprising means for implementing the benefit choice of the participant.

42. The system of claim 41, further comprising information means for making information available to a sponsor of the benefit plan in real-time or near-real-time, the information identifying a financial impact that the choice by the participant has on the sponsor
